(19) United States
(12) Patent Application Publication
(10) Pub. No.: US 2009/0135090 A1
(43) Pub. Date: May 28, 2009

(54) METHOD FOR PROCESSING 3 DIMENSIONAL IMAGE AND APPARATUS THEREOF

(75) Inventor: Young-chan KIM, Uiwang-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/125,130

(22) Filed: May 22, 2008

(30) Foreign Application Priority Data
Nov. 27, 2007 (KR) 10-2007-0121727

(51) Int. Cl. G09G 5/00

(52) U.S. Cl. 345/6

(57) ABSTRACT

A method and apparatus for processing a 3-dimensional (3D) are provided. The image apparatus includes a plurality of displays, an image processing unit which processes the 3D image by varying at least one of a resolution, clearness and position of the 3D image, and a control unit which controls the image processing unit to output the processed 3D image to at least one of the plurality of displays so that a 3-dimensional effect of the 3D image is varied.

### CROSS-REFERENCE TO RELATED APPLICATION

This application claims priority from Korean Patent Application No. 2007-0121727, filed Nov. 27, 2007 in the Korean Intellectual Property Office, the entire disclosure of which is hereby incorporated by reference.

### BACKGROUND OF THE INVENTION

1. Field of the Invention

Methods and apparatuses consistent with the present invention relate to image processing, and more particularly, to processing a 3-dimensional image.

2. Description of the Related Art

Several 3-dimensional (3D) image displaying methods have been introduced recently. One of these methods includes capturing an object through a binocular lens, coupling the captured images, and alternately displaying the right side frame image captured through a right side lens, and the left side frame image captured through a left side lens. This method frequently results in a problem referred to as afterimages, since the right and left side frame images are displayed alternately at brief intervals.

Another 3D image displaying method available arranges two displays at the front and back, and displays a stack of 2D image layers thereon. This method results in what is generally called a Depth-Fused 3D (DFD) display. The DFD display provides image with varying 3-dimensional effect, by varying the brightness of the subject of the display on each layer, or by varying the penetration of the light.

The DFD display suffers less afterimage than the method of alternately displaying the right and left side frame images. However, since the displays are fixed at a predetermined interval, the DFD display 3D images only in a predetermined manner. This inflexible way of displaying 3D images cannot appropriately deal with image distortion occurring according to the location of the viewer.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for processing an image, which provides a 3-dimensional (3D) image in various manners.

The present invention particularly provides a method and apparatus for processing a 3D image optimally according to a location of a viewer, by enabling the viewer to manipulate to change a 3D image processing method.

According to an aspect of the present invention, there is provided an image apparatus for processing a 3-dimensional (3D) image, the apparatus comprising a plurality of displays, an image processing unit which processes the image by varying at least one of a resolution, clearness and position of the image, and a control unit which outputs the image received from the image processing unit to at least one of the plurality of displays so that the 3D image is displayed with varied 3-dimensional effect.

If a 3-dimensional effect varying command is input, the control unit controls the image processing unit to vary at least one of a difference of resolutions, a difference of clearness, and a difference of positions of the image displayed on at least one of the plurality of displays.

If the 3-dimensional effect varying command comprises a 3-dimensional effect increase command, the control unit controls the image processing unit to increase at least one of the difference of resolutions and the difference of clearness of the image displayed on the at least one of the plurality of displays.

If the 3-dimensional effect varying command comprises a 3-dimensional effect decrease command, the control unit controls the image processing unit to decrease at least one of the difference of resolutions and the difference of clearness of the image displayed on the at least one of the plurality of displays.

If the 3-dimensional effect position varying command is input, the control unit controls the image processing unit to cause at least one of the images displayed on the at least one of the plurality of displays to move rightward, leftward, upward or downward.

The display displays a menu to provide information for the adjustment of at least one of the resolution, clearness and position of the image.

According to another aspect of the present invention, there is provided a method for processing a 3-dimensional (3D) image and for realizing the 3D image by displaying a 2D image on a plurality of displays, the method comprising processing the image by varying at least one of a resolution, clearness and position of the image, and displaying the 3D image with varied 3-dimensional effect, by outputting the processed image to at least one of the plurality of displays.

If a 3-dimensional effect varying command is input, the processing comprises processing the image to vary at least one of a difference of resolutions, a difference of clearness, and a difference of positions of the image displayed on the plurality of displays.

If the 3-dimensional effect varying command comprises a 3-dimensional effect increase command, the processing comprises processing the image to increase at least one of the difference of resolutions and the difference of clearness of the image displayed on the plurality of displays.

If the 3-dimensional effect varying command comprises a 3-dimensional effect decrease command, the processing comprises processing the image to decrease at least one of the difference of resolutions and the difference of clearness of the image displayed on the plurality of displays.

If the 3-dimensional effect position varying command is input, the processing comprises processing the image to cause at least one of the images displayed on the plurality of displays to move rightward, leftward, upward or downward.

The method for processing a 3-dimensional (3D) image may further comprise displaying a menu to provide information for the adjustment of at least one of the resolution, clearness and position of the image. [21] According to yet another aspect of the present invention, there is provided an image apparatus for processing a 3-dimensional (3D) image, the apparatus comprising a plurality of displays, and an image processing unit which processes an image by varying at least one of a position, clearness and resolution of the image and thereby varying the 3-dimensional effect of the 3D image, and which outputs the processed image to at least one of the plurality of displays. The plurality of displays comprises a first display arranged closer to a viewer and a second display arranged in back of the first display. The image processing unit comprises a first image processor which processes the image and outputs the processed image to the first display, and a second image processor which processes the image and outputs the processed image to the second display.

If a 3-dimensional effect increase command is input, the first image processor increases at least one of the resolution and clearness of the image, or the second image processor decreases at least one of the resolution and clearness of the image.

If a 3-dimensional effect decrease command is input, the first image processor decreases at least one of the resolution and clearness of the image, or the second image processor increases at least one of the resolution and clearness of the image.

If a 3-dimensional effect position varying command is input, at least one of the first and second image processors moves the position of the image upward, downward, leftward, or rightward.

The display displays a menu provided to change at least one of the position, clearness and resolution of the image.

According to yet another aspect of the present invention, there is provided a computer readable recording medium having recorded thereon a program for activating a method for processing a 3-dimensional (3D) image on the computer, and for realizing the 3D image by displaying a 2D image on a plurality of displays, the method comprises processing the image by varying at least one of a resolution, clearness and position of the image, and displaying the 3D image with varied 3-dimensional effect, by outputting the processed image to at least one of the plurality of displays.

### BRIEF DESCRIPTION OF THE DRAWINGS

The above and other aspects of the present invention will be more apparent from the following detailed description of exemplary embodiments with reference to the accompanying drawings, in which:

FIG. 1 is a block diagram of an image apparatus according to an exemplary embodiment of the present invention;

FIG. 2 is a flowchart provided to explain an image processing to display a 3-dimensional (3D) image using a 2D image of the present invention;

FIGS. 3A and 3B illustrate an example in which a 2D image is displayed on a single display, and FIG. 3C illustrates an example in which 2D image is displayed on a pair of displays;

FIGS. 4A to 4G are provided to explain a 3D image with varying 3-dimensional effect, according to an exemplary embodiment of the present invention; and

FIGS. 5A to 5D illustrate an on-screen display (OSD) menu to adjust resolution, clearness, and position in relation to a 3D image displaying, according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

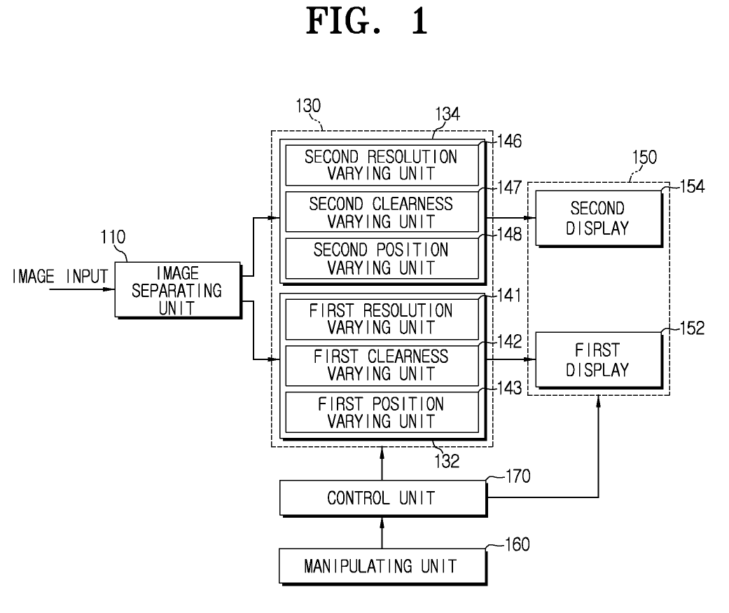

FIG. 1 is a block diagram of an image apparatus according to an exemplary embodiment of the present invention.

Referring to FIG. 1, the image apparatus includes an image separating unit 110, an image processing unit 130, a display 150, a manipulating unit 160, and a control unit 170.

The image separating unit 110 separates an input image according to a frame unit. Accordingly, the image separating unit 110 separates the input image into a front frame image and a back frame image. Herein, each of the frames included in the received image has a front frame image fused with a back frame image.

Upon separating the received frame image into a front frame image and a back frame image, the image separating unit 110 sends the front frame image to a first image processor 132 and sends the back frame image to a second image processor 134.

The image processing unit 130 carries out an image processing of the image received from the image separating unit 110 to enable display of the received image. The image processing unit 130 includes the first and second image processors 132 and 134. The first and second image processors 132 and 134 each include resolution varying units 141 and 146, clearness varying units 142 and 147, and position varying units 143 and 148.

The resolution varying units 141 and 146 enlarge or reduce the size of the received image to suit for the size of the display, so that the image has a resolution corresponding to that of the image apparatus. Specifically, upon receipt of a resolution varying control signal from the control unit 170, which will be explained below, the resolution varying units 141 and 146 increase or decrease the resolution of the image from an existing resolution, and send the varied image to the display 150. The ‘existing resolution’ refers to a resolution which is used by the image processing unit 130 to change the image to match the resolution of the image apparatus.

The clearness varying units 142 and 147 increase or decrease the clearness of the received image from an existing clearness. The ‘existing clearness’ refers to a predetermined clearness which is previously determined in the image generating process such as photographing. The image processing unit 130 processes the signal according to the existing original clearness, if a clearness varying control signal is not received from the control unit 170. Otherwise, if a clearness varying control signal is received from the control unit 170, the clearness varying units 142 and 147 increase or decrease the existing clearness.

The resolution and clearness are closely related with one another, since the clearness increases as the resolution becomes higher. However, the resolution does not necessarily increase as the clearness increases. Accordingly, a function to vary the resolution is independent from a function to vary the clearness. The resolution varying units 141 and 146 and the clearness varying units 142 and 147 may be implemented as a scaler of the image processing unit 130.

The position varying units 143 and 148, or display driving units, vary the position of an image on the display 150. In scanning an image on the display 150, the position varying units 143 and 148 cause the image to be moved leftward, rightward, upward or downward and displayed on a changed location of the display 150, by scanning the image earlier or later than a predetermined scan time.

The display 150 displays an image, and includes a first display 152 arranged closer to the viewer, and a second display 154 arranged in back of the first display 152. The first display 152 displays an image processed at the first image processor 132, and the second display 154 displays an image processed at the second image processor 134. The display 150 may additionally display an OSD menu to provide information for the purpose of dimension adjustment.

The manipulating unit 160 receives a user manipulation command and transmits the command to the control unit 170. The manipulating unit 160 may be integrally formed with an image apparatus, or provided separately. Additionally, the manipulating unit 160 may be implemented as a user interface to enable a user to input a command through a menu screen. Alternatively, the manipulating unit 160 may be implemented as a combination of a remote controller to input a user command, and a light receiving unit to receive the signal output from the remote controller and transmit it to the control unit 170.

The control unit 170 analyzes the user command received from the manipulating unit 160, which will be explained in detail below, and controls the operation of the image apparatus accordingly. For example, in response to a command received through the manipulating unit 160 to operate a 3-dimensional effect adjustment mode among the operation modes of the image apparatus, the control unit 170 generates a plurality of menus related to 3-dimensional effect adjustment and displays the generated menus on the display 150.

The menus related to 3-dimensional effect adjustments according to an exemplary embodiment of the present invention may include a resolution, clearness and position, among others. The control unit 170 sends a corresponding control signal to the image processing unit 130 in response to a command for 3-dimensional effect adjustment received through the manipulating unit 160.

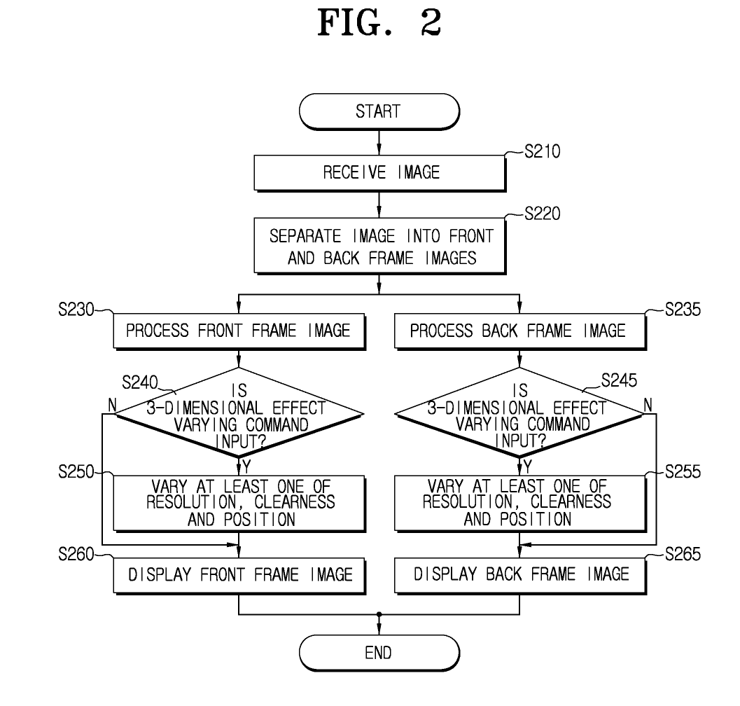

The operation of the image apparatus illustrated in FIG. 1 will be explained in detail below, with reference to FIG. 2. FIG. 2 is a flowchart provided to explain an image processing to display a 3-dimensional (3D) image using a 2D image according to an exemplary embodiment of the present invention.

In operation S210, a 3-dimensional (3D) image is input. In operation S220, the image separating unit 110 separates the 3D image into a front frame image and a back frame image. Accordingly, the image separating unit 110 sends the front frame image to the first image processor 132, and sends the back frame image to the second image processor 134.

In operation S230, the first image processor 132 processes the front frame image into a displayable signal form, and in operation S235, the second image processor 134 processes the back frame image 330 into a displayable signal form. Specifically, the image processing unit 130 may process the image according to a predetermined resolution, clearness and position. The ‘predetermined resolution, clearness and position’ herein refers to the information to be applied for the image processing operation performed by default at the image processing unit 130, when a command for 3-dimensional effect adjustment is not received.

In operations S240 and S245, the control unit 170 determines whether a command for 3-dimensional effect adjustment is received or not. Specifically, a user may input a 3-dimensional effect increase/decrease command through the manipulating unit 160, regarding the received 3D image. Accordingly, the control unit 170 determines the reception of the 3-dimensional effect adjustment command, and sends a corresponding control signal to the first image processor 132 and/or the second image processor 134 of the image processing unit 130.

In operation S240-Y and S245-Y, if the 3-dimensional effect adjustment command is received, in operations S250 and S255, the first image processor 132 and/or the second image processor 134 adjusts one of the resolution, clearness and position according to the received command. Herein, the operations of processing a received image, and adjusting at least one of the resolution, clearness and position in response to a 3-dimensional effect adjustment command, are explained as being performed in sequence for convenience. However, one will understand that other examples are also possible. For example, on receipt of a 3-dimensional effect adjustment command, the image processing unit 130 may process the image based on a varied resolution, clearness and position.

In operations S260 and S265, the front frame image and the back frame image are displayed with adjusted 3-dimensional effect. The front and back frame images may desirably be displayed concurrently.

In operations S240-N and S245-N, if a 3-dimensional effect adjustment command is not input, in operations S260 and S265, an image is displayed with unadjusted 3-dimensional effect. The first and second image processors 132 and 134 operate independently from each other, in processing signals with varied 3-dimensional effect. Accordingly, only one, or both of the first and second image processors 132 and 134 may process the signal with varied 3-dimensional effect.

As a result, an optimized 3D image is displayed, with various 3-dimensional effects which are adjusted according to a user's command.

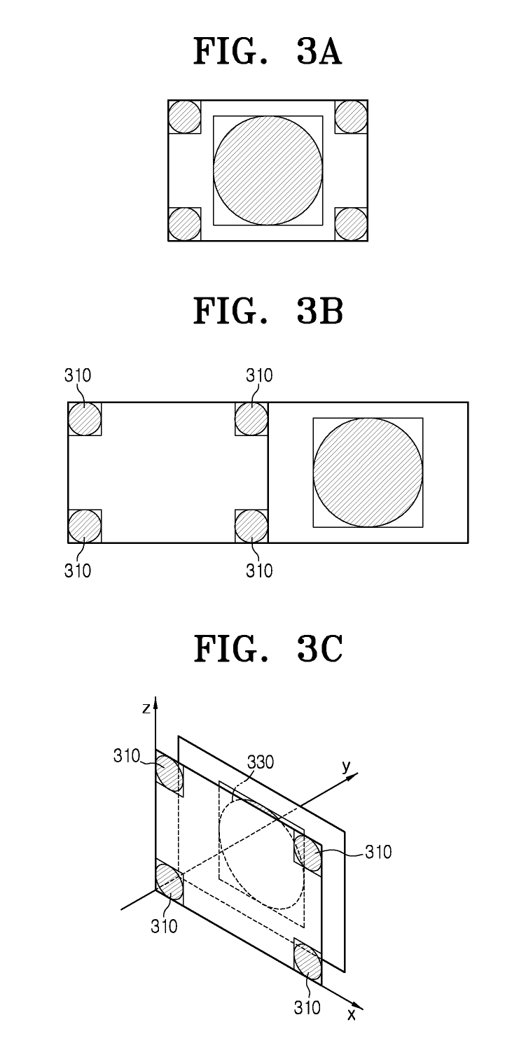

FIGS. 3A and 3B illustrate an example in which a 2D image is displayed on a single display, and FIG. 3C illustrates an example in which 2D image is displayed on a pair of displays.

Specifically, FIG. 3A illustrates a 2-dimensional image displayed on a single display. When a 2D image is displayed on one display as illustrated in FIG. 3A, a frame image is input and the input image is processed and displayed. In this case, the 2D image is displayed on the display without depth.

FIG. 3B illustrates a DFD image, which is input as a 2D image. As shown, the image is divided into a front frame image 310 and a back frame image 330, and processed so that the front frame image 310 is displayed on the first display, and the back frame image 330 is displayed on the second display. Since the 2D image is displayed on a plurality of displays, the image can be displayed at depth.

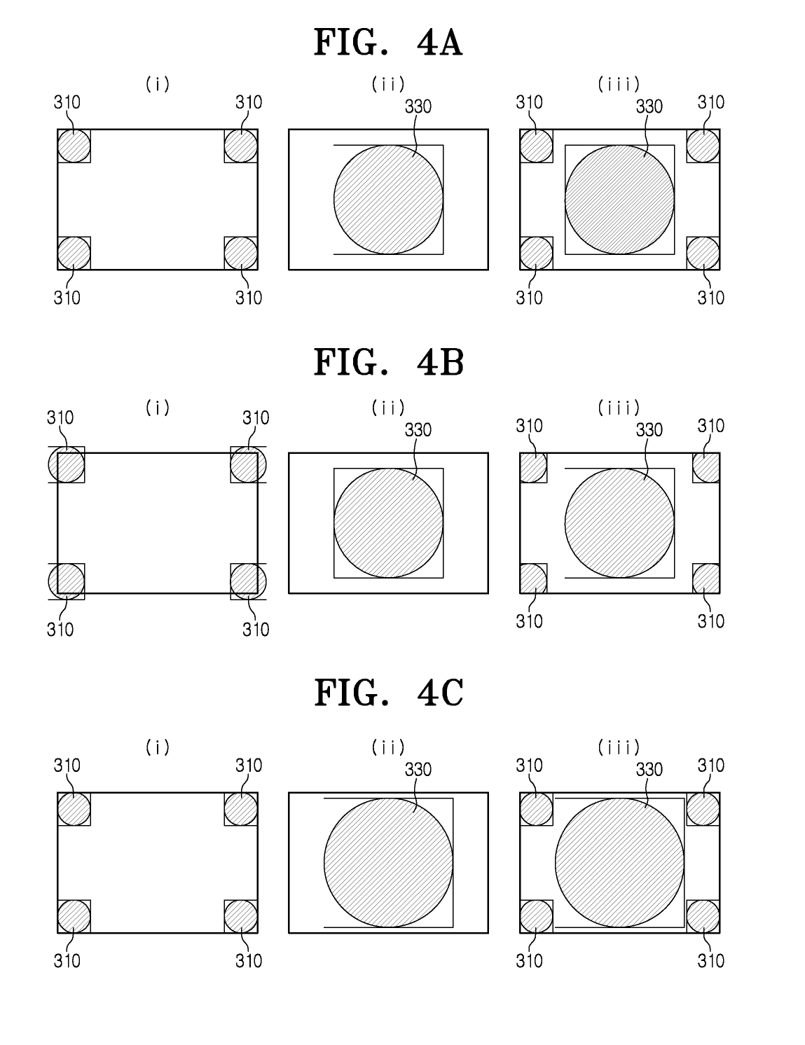

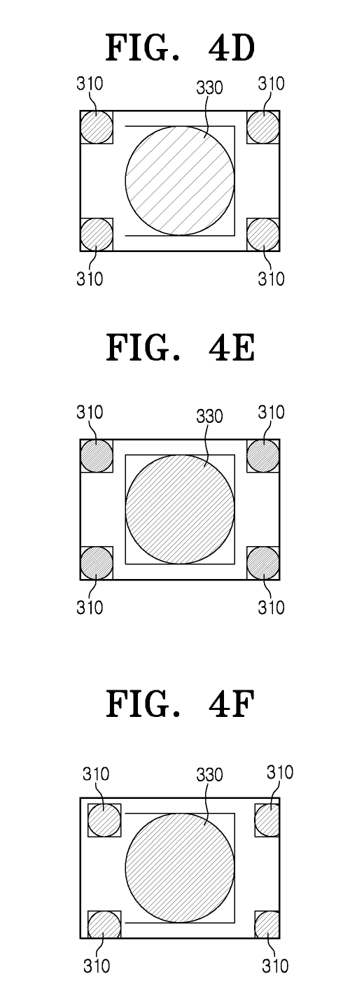

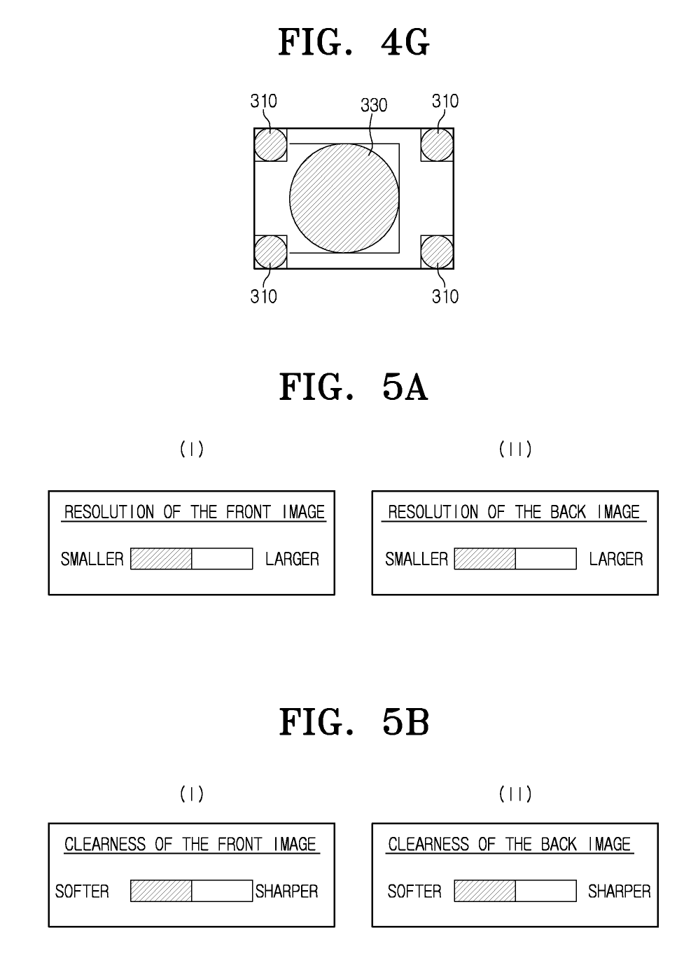

FIGS. 4A to 4G are provided to explain a 3D image with varying 3-dimensional effect, according to an exemplary embodiment of the present invention.

FIG. 4A illustrates an image displayed when no 3-dimensional effect adjustment command is input. The first and second image processors 132 and 134 process a received image into a displayable signal form as illustrated in FIG. 4A-(i) and FIG. 4A-(ii). As a result, the display displays the image in the form as illustrated in FIG. 4A-(iii). The front frame image 310 of FIG. 4A-(iii) is displayed on the first display 152, and the back frame image 330 of FIG. 4A-(iii) is displayed on the second display 154. The image of FIG. 4A-(iii) is shown in a front view.

FIG. 4B illustrates an image displayed in response to a 3-dimensional effect adjustment command. The first image processor 132 processes the front frame image 310 with increased resolution as shown in FIG. 4B-(i), and the second image processor 134 processes the back frame image 330 with predetermined resolution as shown in FIG. 4B-(ii). As a result, the display 150 displays an image having a large difference of resolutions as shown in FIG. 4B-(iii). Since the front frame image 310 has an increased resolution, the image is displayed at greater 3-dimensional effect than the image shown in FIG. 4A-(iii). The 3-dimensional effect increase command may be executed by alternative manners. For example, the back frame image 330 may be adjusted to have reduced resolution, instead of increasing the resolution of the front frame image 310, or, the resolution of the front frame image 310 may be increased, while reducing the resolution of the back frame image 330.

FIG. 4C illustrates an image displayed in response to a 3-dimensional effect decrease command. As shown in FIG. 4C-(i), the first image processor 132 processes the front frame image 310 at a predetermined resolution, but processes the back frame image 330 at a greatly increased resolution. As a result, the display 150 displays an image in a manner exemplified in FIG. 4C-(iii). Since the back frame image 330 has the increased resolution, the resultant image has a smaller 3-dimensional effect than the image shown in FIG. 4A-(iii). The 3-dimensional effect decrease command may be executed by alternative manners. For example, the front frame image 310 may be adjusted to have reduced resolution, or, the resolution of the front frame image 310 may be decreased, while increasing the resolution of the back frame image 330.

Meanwhile, the 3-dimensional effect of the image may also be adjusted by using clearness. FIG. 4D shows an image displayed at increased 3-dimensional effect, due to the clearness of the back frame image 330 being adjusted down, and FIG. 4E shows an image displayed also at increased 3-dimensional effect, due to the front frame image 310 being adjusted up significantly. Although not shown in the drawings, alternatives are also possible. For example, the 3-dimensional effect may be reduced by increasing the clearness of the back frame image 330, or reducing the clearness of the front frame image 310. In other words, the 3-dimensional effect may be increased or decreased by increasing or decreasing the difference of clearness between the front and back frame images 310 and 330.

FIGS. 4F and 4G illustrate a 3-dimensional (3D) image displayed at a varied position according to an exemplary embodiment of the present invention. FIG. 4F illustrates a 3D image displayed by moving the front frame image 310 downward. If the image apparatus is placed higher than the vantage point of a viewer, and if the 3D image of FIG. 4A-(iii) is displayed, the viewer perceives the back frame image 310 to be distorted downward. In this case, the front frame image 310 may be displayed in a lower position from the predetermined position, to prevent the viewer's perception of the distortion from his standpoint.

Alternatively, the back frame image 330 may be moved to a higher position from the designated position to prevent an image distortion due to the image apparatus being placed higher from the vantage point of a viewer. If the image apparatus is placed lower than the vantage point of a viewer, the image distortion can be prevented by the reverse manner.

FIG. 4G illustrates a 3D image displayed when the position of the back frame image 330 is moved leftward. If a viewer is watching the image from the right side of the image apparatus, the possible image distortion can be prevented by moving the back frame image 330 leftward, or moving the front frame image 310 rightward as shown in FIG. 4G.

As explained above, the position varying units 143 and 148, or display driving units, scan an image on the display 150 with reference to a synchronous signal to change the position of the image. Since the viewer can change the position of the image to minimize image distortion occurring due to a discrepancy between the image apparatus and the vantage point of the viewer, a 3D image is provided in the most optimum condition.

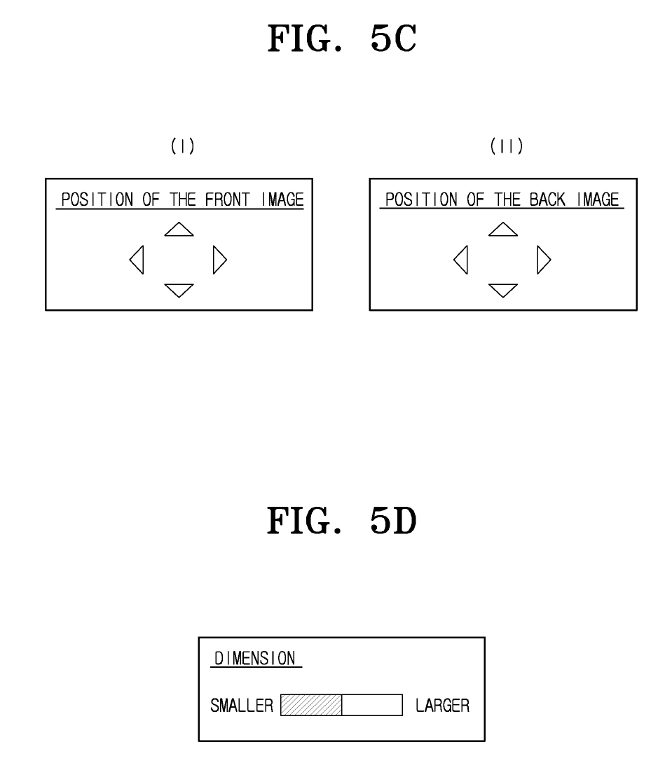

FIGS. 5A to 5D illustrate an on-screen display (OSD) menu to adjust resolution, clearness, and position in relation to a 3D image displaying, according to an exemplary embodiment of the present invention.

FIGS. 5A-(i) and 5A-(ii) illustrate an OSD menu provided for adjustment of resolution, FIGS. 5B-(i) and 5B-(ii) illustrate an OSD menu provided for adjustment of clearness, and FIGS. 5C-(i) and 5C-(ii) illustrate an OSD menu provided for adjustment of position. Accordingly, a viewer can adjust the resolution, clearness and position of the front and back frame images individually.

Additionally, an OSD menu may be provided for adjustment of 3-dimensional effect (FIG. 5D). As explained above, in response to a 3-dimensional effect increase command input by a viewer using the OSD menu illustrated in FIG. 5D, the control unit 170 generates a control signal to increase either a difference of resolutions or a difference of clearness of an image, and sends the generated control signal to the image processing unit 130. Since the control unit 170 controls the image processing unit 130 according to a predetermined condition in response to a command to vary the 3-dimensional effect input by a viewer through the OSD menu displayed on FIG. 5D, the viewer is provided with 3D images conveniently, without having to know the details of manipulating the image apparatus.

The 3D image processing method according to the exemplary embodiments of the present invention may be recorded on a computer readable medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains. In this case, the respective function blocks are operated by activating a program according to the exemplary embodiments of the present invention on the computer.

As explained above, since 3D images are adjusted and displayed by various manners, a viewer is provided with various 3D images.

Furthermore, a viewer is able to manipulate and change the 3-dimensional effect of the 3D image to meet his preference.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. An image apparatus for processing a 3-dimensional (3D) image, the image apparatus comprising:
a plurality of displays;
an image processing unit which processes a 3D image by varying at least one of a resolution, clearness and position of the 3D image; and
a control unit which controls the image processing unit to output the processed 3D image to at least one of the plurality of displays so that a 3-dimensional effect of the 3D image is varied.

2. The image apparatus of claim 1, further comprising an image separating unit which separates a 3D image into a plurality of images.

3. The image apparatus of claim 2, wherein the plurality of images comprises a front image and a back image.

4. The image apparatus of claim 3, wherein the plurality of displays comprises a front display and a back display.

5. The image apparatus of claim 4, wherein the front image is displayed on the front display and the back image is displayed on the back display.

6. The image apparatus of claim 3, wherein the control unit controls the image processing unit to vary at least one of a difference of resolutions, a difference of clearness, and a difference of positions between the front image and the back image displayed on the plurality of displays.

7. The image apparatus of claim 6, wherein the control unit controls the image processing unit to increase at least one of the difference of resolutions and the difference of clearness between the front image and the back image displayed on the plurality of displays.

8. The image apparatus of claim 6, wherein the control unit controls the image processing unit to decrease at least one of the difference of resolutions and the difference of clearness between the front image and the back image displayed on the plurality of displays.

9. The image apparatus of claim 6, wherein the control unit controls the image processing unit to cause at least one of the front image and the back image displayed on the plurality of displays to move rightward, leftward, upward or downward.

10. The image apparatus of claim 1, wherein the plurality of displays display a menu which provides information for the adjustment of at least one of the resolution, clearness and position of the 3D image.

11. A method for processing a 3-dimensional (3D) image, for realizing the 3D image by displaying a 2D image on a plurality of displays, the method comprising:
processing the 3D image by varying at least one of a resolution, clearness and position of the 3D image; and
displaying the 3D image with a varied 3-dimensional effect, by outputting the processed 3D image to at least one of the plurality of displays.

12. The method of claim 11, wherein the 3D image is split into a front image and a back image, and the processing comprises processing at least one of the front image and the back image to vary at least one of a difference of resolutions, a difference of clearness, and a difference of positions between the front image and the back image displayed on the plurality of displays.

13. The method of claim 12, wherein the processing comprises processing at least one of the front image and the back image to increase at least one of the difference of resolutions and the difference o f clearness between the front image and the back image displayed on the plurality of displays.

14. The method of claim 12, wherein the processing comprises processing at least one of the front image and the back image to decrease at least one of the difference of resolutions and the difference of clearness between the front image and the back image displayed on the plurality of displays.

15. The method of claim 12, wherein the processing comprises processing at least one of the front image and the back image to cause the at least one of the front image and the back image displayed on the plurality of displays to move rightward, leftward, upward or downward.

16. The method of claim 11, further comprising displaying a menu which provides information for the adjustment of at least one of the resolution, clearness and position of the 3D image.

17. An image apparatus for processing a 3-dimensional (3D) image, the image apparatus comprising:
a plurality of displays; and
an image processing unit which processes image by varying at least one of a position, clearness and resolution of the image and thereby varying a 3-dimensional effect of the 3D image, and which outputs the processed image to at least one of the plurality of displays,
wherein the plurality of displays comprise,
a first display arranged closer to a viewer and a second display arranged in back of the first display,
and wherein the image processing unit comprises,
a first image processor which processes the image and outputs the processed image to the first display, and a second image processor which processes the image and outputs the processed image to the second display.

18. The image apparatus of claim 17, wherein a difference of resolutions and a difference of clearness of the 3D image is increased by one of the first image processor increasing at least one of the resolution and clearness of the image, or the second image processor decreasing at least one of the resolution and clearness of the image.

19. The image apparatus of claim 17, wherein a difference of resolutions and a difference of clearness of the 3D image is decreased by one of the first image processor decreasing at least one of the resolution and clearness of the image, or the second image processor increasing at least one of the resolution and clearness of the image.

20. The image apparatus of claim 17, wherein at least one of the first and second image processors moves the position of the image upward, downward, leftward, or rightward.

21. The image apparatus of claim 17, wherein the plurality of displays display a menu provided to change at least one of the position, clearness and resolution of the image.

22. A computer readable recording medium having recorded thereon a program for activating a method for processing a 3-dimensional (3D) image on the computer, the method realizing the 3D image by displaying a 2D image on a plurality of displays, the method comprising:
processing the 2D image by varying at least one of a resolution, clearness and position of the 2D image; and
displaying the 3D image with a varied 3-dimensional effect, by outputting the processed 2D image to at least one of the plurality of displays.
